(19) United States
(12) Patent Application Publication
(10) Pub. No.: US 2026/0229576 A1
(43) Pub. Date: Aug. 6, 2026

(54) APPARATUS FOR MANUFACTURING SECONDARY BATTERY

(71) Applicant: SK On Co., Ltd., Seoul (KR)

(72) Inventor: Dong Hyeon OH, Daejeon (KR)

(21) Appl. No.: 19/460,328

(22) Filed: Jan. 27, 2026

(30) Foreign Application Priority Data
Jan. 31, 2025 (KR) 10-2025-0012201

(51) Int. Cl. H01M 10/04

(52) U.S. Cl. CPC H01M 10/0404

(57) ABSTRACT

The present disclosure discloses an apparatus for manufacturing a secondary battery. According to the present disclosure, an apparatus for manufacturing a secondary battery is provided, which includes: a body provided with an access hole; a cap supporter disposed on the body to support a cap; a pin guide configured to adjust a position of a connection pin assembled to the cap; and a vision camera configured to identify the position of the connection pin through the access hole.

### CROSS-REFERENCE TO RELATED APPLICATION

The present application claims priority to and the benefit of Korean Patent Application No. 10-2025-0012201, filed on Jan. 31, 2025 in the Korean Intellectual Property Office, the entire disclosure of which is incorporated herein by reference.

### TECHNICAL FIELD

Embodiments of the present disclosure relate to an apparatus for manufacturing a secondary battery.

### BACKGROUND

A secondary battery is one of energy storage means which can be charged and discharged through electrochemical reactions. The secondary battery is widely used in various fields in which electrical energy is used. For example, secondary batteries are widely utilized in the field of mobile devices such as a cell phone, a notebook, a tablet, and the like, and are being explored for wider utilization in the field of transportation means such as vehicles, aircraft, ships, and the like. Further, demand for secondary batteries is also rapidly increasing in the field of energy storage systems (ESSs) for utilizing surplus electricity.

Secondary batteries may be provided with electrode assemblies accommodated inside cases. The cases may be classified according to material, shape, etc., and for example, pouch type, cylindrical type, prismatic type, coin type cases, and the like are known. In some embodiments, the cases may have openings for insertion of electrode assemblies. These openings may be appropriately sealed by caps after assembly of the electrode assembly. Additionally, the caps may be provided with electrode terminals for electrical connection with the electrode assembly. These electrode terminals need to be assembled in proper alignment with the electrode assembly during the process of sealing the openings.

### SUMMARY

Some embodiments of the present disclosure are directed to providing an apparatus for manufacturing a secondary battery.

Further, some embodiments of the present disclosure are directed to providing an apparatus for manufacturing a secondary battery which is capable of appropriately aligning the assembly position between an electrode assembly and a cap during the assembly process of a secondary battery.

In addition, some embodiments of the present disclosure are directed to providing an apparatus for manufacturing a secondary battery which is capable of preventing assembly defects between an electrode assembly and a cap.

In addition, some embodiments of the present disclosure are directed to providing an apparatus for manufacturing a secondary battery which is capable of preventing increased manufacturing costs and reduced quality due to assembly defects.

Some embodiments of the present disclosure may be widely applied in the field of green technologies such as an electric vehicle and a battery charging station as well as solar power generation and wind power generation using batteries. Further, some embodiments of the present disclosure may be used in an eco-friendly electric vehicle, a hybrid vehicle, and the like to prevent climate change by suppressing air pollution and greenhouse gas emissions.

According to one aspect of the present disclosure, an apparatus for manufacturing a secondary battery is provided, which includes: a body provided with an access hole; a cap supporter disposed on the body to support a cap; a pin guide configured to adjust a position of a connection pin assembled to the cap; and a vision camera configured to identify the position of the connection pin through the access hole.

In some embodiments, the access hole may comprise: a first space in which the cap is disposed; and a second space which extends from the first space and through which an assembly hole provided in the cap is exposed to the vision camera.

In some embodiments, the cap supporter may be provided to allow the cap to advance toward the connection pin.

In some embodiments, the cap may be provided so that a first surface thereof is advanced toward the connection pin to be assembled with the connection pin, and the cap supporter may be fastened to a second surface of the cap, which is opposite to the first surface, to support the cap.

In some embodiments, the pin guide may be provided so that the pin guide is advanced toward the connection pin to be coupled to the connection pin, or retracted from the connection pin to be separated from the connection pin.

In some embodiments, the pin guide may be provided to adjust the position of the connection pin on a plane intersecting an assembly direction of the connection pin.

In some embodiments, the pin guide may be provided to be movable on a plane intersecting an assembly direction of the connection pin.

In some embodiments, the pin guide may be provided to be movable along a first rail and a second rail that extend in directions intersecting each other.

In some embodiments, the pin guide may be provided in a plate form having a predetermined thickness in an assembly direction of the connection pin to enter a space between the connection pin and the cap that are disposed in a standby position.

In some embodiments, the pin guide may have one end provided with a pin-coupling groove coupled to the connection pin.

In some embodiments, the pin guide may comprise: a first pin guide coupled to one side of the connection pin; and a second pin guide provided to correspond to the first pin guide to be coupled to the remaining region of the connection pin.

In some embodiments, the vision camera may be provided to scan an assembly hole provided in the cap through the access hole and identify whether the connection pin is aligned through an occupied area of the connection pin exposed through the assembly hole.

In some embodiments, the vision camera may be provided to identify whether the connection pin is aligned when the connection pin approaches a standby position, and the pin guide may be provided to adjust the position of the connection pin to an appropriate state when the identified alignment state is not suitable.

In some embodiments, the pin guide may be provided to be coupled to the connection pin when the connection pin approaches a standby position, and the cap supporter may be provided to advance the cap while the pin guide is coupled to the connection pin so that a portion of the connection pin is inserted into an assembly hole provided in the cap.

In some embodiments, the pin guide may be provided to be separated from the connection pin when the portion of the connection pin is inserted into the assembly hole, and the cap supporter may be provided to advance the cap when the pin guide is separated from the connection pin so that the connection pin is fully inserted into the assembly hole.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a side view showing an apparatus for manufacturing a secondary battery according to one embodiment of the present disclosure;

FIG. 2 is a front view of the manufacturing apparatus shown in FIG. 1;

FIG. 3 is a side view showing a secondary battery being processed;

FIG. 4 is a front view of the secondary battery being processed shown in FIG. 3;

FIG. 5 is a side view showing a state in which the secondary battery being processed shown in FIG. 3 is inserted into a case;

FIG. 6 is a first operating state view of the manufacturing apparatus shown in FIG. 1;

FIG. 7 is a second operating state view of the manufacturing apparatus shown in FIG. 1;

FIG. 8 is a third operating state view of the manufacturing apparatus shown in FIG. 1;

FIG. 9 is a fourth operating state view of the manufacturing apparatus shown in FIG. 1;

FIG. 10 is a fifth operating state view of the manufacturing apparatus shown in FIG. 1; and

FIG. 11 is a sixth operating state view of the manufacturing apparatus shown in FIG. 1.

### DETAILED DESCRIPTION

Hereinafter, the present disclosure will be described in detail with reference to the accompanying drawings. However, this is merely exemplary and the present disclosure is not limited to the specific embodiments illustratively described.

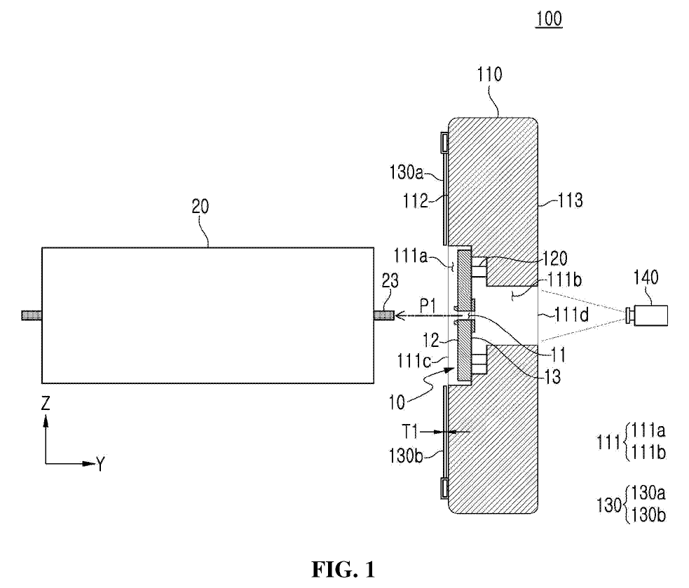

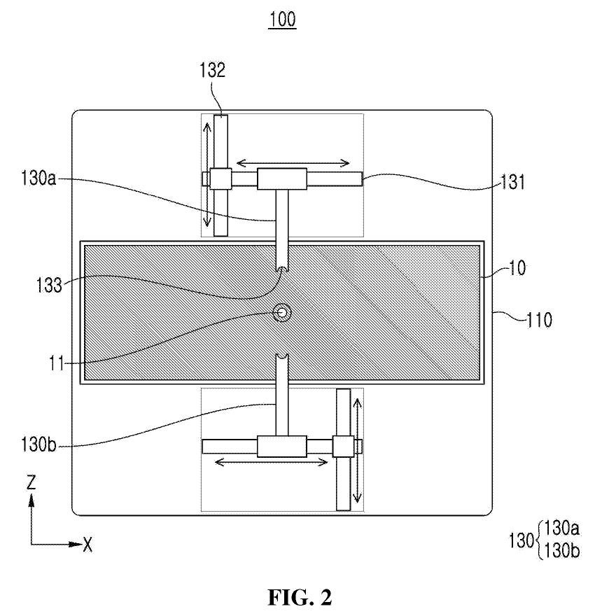

FIG. 1 is a side view showing an apparatus for manufacturing a secondary battery according to one embodiment of the present disclosure. FIG. 2 is a front view of the manufacturing apparatus shown in FIG. 1.

For convenience, hereinafter, based on the coordinate axes shown in FIG. 1 and the like, an x-axis direction will be referred to as a left-right direction, a y-axis direction will be referred to as a front-rear direction, and a z-axis direction will be referred to as an up-down direction.

Referring to FIGS. 1 and 2, in some embodiments, an apparatus for manufacturing a secondary battery (hereinafter referred to as a “manufacturing apparatus 100”) may comprise: a body 110 provided with an access hole 111; a cap supporter 120 disposed on the body 110 to support a cap 10; a pin guide 130 for adjusting the position of a connection pin 23 assembled to the cap 10; and a vision camera 140 for identifying the position of the connection pin 23 through the access hole 111.

Specifically, in some embodiments, the manufacturing apparatus 100 may be provided with the body 110. The body 110 may form an overall exterior of the manufacturing apparatus 100. However, the specific shape of the body 110 may be modified in various ways and is not necessarily limited to the illustrated embodiment.

In some embodiments, the body 110 may have the access hole 111. The access hole 111 may be provided to pass through the body 110 in an assembly direction P1 of the cap 10. In the illustrated embodiment, the assembly direction P1 of the cap 10 corresponds to the front-rear direction, and accordingly, the access hole 111 may be formed to pass from a front surface 112 to a rear surface 113 of the body 110 in the front-rear direction.

In some embodiments, the access hole 111 may have a first space 111a and a second space 111b. The first space 111a may be provided as a portion of the front of the access hole 111, and the second space 111b may be provided as a portion of the rear of the access hole 111. The first space 111a may be formed to extend a predetermined depth toward the inside of the body 110 from a first opening 111c of the front surface 112. Additionally, the second space 111b may be formed to extend a predetermined depth toward the inside of the body 110 from a second opening 111d of the rear surface 113. These first and second spaces 111a and 111b may form the access hole 111 extending from the first opening 111c in the front surface 112 to the second opening 111d in the rear surface 113.

In some embodiments, the first space 111a may be used as a space where the cap 10 is disposed. That is, the cap 10 may be disposed in the first space 111a. In some embodiments, the second space 111b may be used as a passage for the vision camera 140 to scan an assembly hole 11. That is, the second space 111b may be provided to expose the assembly hole 11 to the vision camera 140.

In some embodiments, the size, shape, or the like of the first space 111a may be determined by reflecting the size, shape, or the like of the cap 10. In addition, the size, position, or the like of the second space 111b may be determined by reflecting the size, position, or the like of the assembly hole 11. For example, as shown in the drawing, the first space 111a may be provided in a shape having a greater width than the second space 111b so that the cap 10 can be appropriately disposed, and the second space 111b may be disposed at a central region of the cap 10 to appropriately expose the assembly hole 11. However, the sizes, shapes, positions, or the like of the first and second spaces 111a and 111b may be modified in various ways as needed and are not necessarily limited to the examples described above.

Meanwhile, in some embodiments, the manufacturing apparatus 100 may be provided with the cap supporter 120. The cap supporter 120 may be provided to be disposed on the body 110 to support the cap 10. For example, the cap supporter 120 may be provided to be disposed in the first space 111a to support a rear surface of the cap 10. Additionally, the cap supporter 120 may be provided to be detachably attached to the cap 10. That is, the cap supporter 120 may be coupled to the cap 10 for assembly of the cap 10, or provided to be separable from the cap 10 after the cap 10 is assembled. Various known methods may be utilized for the detachably attached structure between the cap supporter 120 and the cap 10, but the present disclosure is not particularly limited.

In some embodiments, the cap supporter 120 may be provided to move forward and backward. Accordingly, the cap supporter 120 may be provided to allow the cap 10 to advance toward the connection pin 23 to be assembled. Additionally, the cap supporter 120 may be separated from the cap 10 after the cap 10 is assembled and returned to its initial position again.

In some embodiments, the cap 10 may have a first surface 12 disposed toward the connection pin 23 and a second surface 13 disposed on an opposite side of the first surface 12. The cap 10 may be provided so that the first surface 12 is advanced toward the connection pin 23 by the cap supporter 120 and assembled with the connection pin 23. In addition, the cap supporter 120 may be fastened to the second surface 13, which is opposite to the assembly direction, to support the cap 10.

Meanwhile, in some embodiments, the manufacturing apparatus 100 may be provided with the pin guide 130. The pin guide 130 may be provided to adjust the position of the connection pin 23 assembled with the cap 10. Specifically, the connection pin 23 provided in an electrode assembly 21 may be assembled with the assembly hole 11 provided in the cap 10, and the pin guide 130 may be provided to appropriately adjust the assembly position between the connection pin 23 and the assembly hole 11.

In some embodiments, the pin guide 130 may be provided to be detachably attached to the connection pin 23. That is, the pin guide 130 may be provided to advance toward the connection pin 23 to be coupled to the connection pin 23, or retract from the connection pin 23 to be separated from the connection pin 23. Accordingly, the pin guide 130 may be coupled to the connection pin 23 to adjust the position of the connection pin 23, or appropriately separated from the connection pin 23 for assembly of the connection pin 23 and the assembly hole 11.

In some embodiments, the pin guide 130 may be provided to adjust the position of the connection pin 23 with respect to the assembly hole 11. Specifically, the pin guide 130 may be provided to be movable within a predetermined range on a plane intersecting the assembly direction P1 of the connection pin 23. That is, in the illustrated embodiment, the pin guide 130 may be provided to be movable on the xz plane. Additionally, the pin guide 130 may be provided to adjust the position of the connection pin 23 through the above movement. That is, in the illustrated embodiment, the pin guide 130 may be provided to move a predetermined distance while coupled to the connection pin 23 to adjust the position of the connection pin 23 on the xz plane.

In some embodiments, the pin guide 130 may be provided to be movable along rails 131 and 132. In some embodiments, the rails 131 and 132 may comprise a first rail 131 and a second rail 132 which extend in directions intersecting each other. For example, as shown in the drawing, the first rail 131 may laterally extend on the front surface 112 of the body 110, and the second rail 132 may vertically extend on the front surface 112 of the body 110. Additionally, the pin guide 130 may be provided to be movable along the first rail 131, and the first rail 131 may be provided to be movable along the second rail 132. Accordingly, the pin guide 130 may be movably provided in the left-right and up-down directions along the first and second rails 131 and 132.

In some embodiments, the pin guide 130 may be provided to be moved by a predetermined driving unit. For reference, the driving unit is not shown in FIG. 1 and the like. The driving unit may be provided to move the pin guide 130 along the first and second rails 131 and 132. Accordingly, the assembly position between the pin guide 130 or the connection pin 23 coupled thereto and the assembly hole 11 may be appropriately adjusted. Various known means may be utilized for the driving unit, but are not particularly limited. For example, the driving unit may be provided as a servo motor installed on the pin guide 130 or the first and second rails 131 and 132.

Meanwhile, in some embodiments, the pin guide 130 may be provided in a plate form having a predetermined thickness T1 in the assembly direction P1 of the connection pin 23. For example, as shown in the drawing, the connection pin 23 may be provided to be assembled with the cap 10 in the front-rear direction, and the pin guide 130 may be provided in the plate form having the predetermined thickness T1 in the front-rear direction. The pin guide 130 having such a plate form may more smoothly enter the space between the connection pin 23 and the cap 10 which are disposed in standby positions.

In some embodiments, the pin guide 130 may be provided with a pin-coupling groove 133. The pin-coupling groove 133 may be provided at one end of the pin guide 130 in a longitudinal direction, and provided to be coupled to the connection pin 23. That is, the pin-coupling groove 133 may be provided to be coupled to the connection pin 23 or separated from the connection pin 23 according to the movement of the pin guide 130. In some embodiments, the pin-coupling groove 133 may have a shape corresponding to an outer surface of the connection pin 23 and may be provided to be coupled to the connection pin 23 by pressing and fixing the outer surface of the connection pin 23.

In some embodiments, the pin guide 130 may be provided as a plurality of pin guides 130. For example, as shown in the drawing, the pin guide 130 may comprise a first pin guide 130a and a second pin guide 130b which are vertically disposed on the front surface 112 of the body 110. The first pin guide 130a may be disposed above the first opening 111c, and the second pin guide 130b may be disposed below the first opening 111c to correspond thereto. The first and second pin guides 130a and 130b may be provided to clamp and fix the connection pin 23 in the vertical direction. That is, the first pin guide 130a and the second pin guide 130b may be provided such that the first pin guide 130a is coupled to an upper region of the connection pin 23 and the second pin guide 130b is coupled to a lower region of the connection pin 23, which is the remaining region, to clamp the connection pin 23 up and down.

Meanwhile, in some embodiments, the manufacturing apparatus 100 may comprise the vision camera 140. The vision camera 140 may be provided to identify the position of the connection pin 23 through the access hole 111. Specifically, the vision camera 140 may be provided to be disposed adjacent to the rear surface 113 of the body 110 to scan the assembly hole 11 through the second opening 111d. Here, the connection pin 23 may be exposed through the assembly hole 11, and the vision camera 140 may be provided to identify whether the connection pin 23 is appropriately aligned through the exposed occupied area of the connection pin 23. That is, the vision camera 140 may be provided to identify the alignment state of the connection pin 23 through the occupied area that the connection pin 23 occupies in the assembly hole 11. This will be further explained in relation to the operation of the present embodiment described below.

Meanwhile, in some embodiments, the manufacturing apparatus 100 as described above may be used to assemble the cap 10 into a secondary battery 20 being processed. Specifically, the manufacturing apparatus 100 may be used to assemble the connection pin 23 provided in the secondary battery 20 being processed and the assembly hole 11 provided in the cap 10 in assembling the cap 10. Here, the manufacturing apparatus 100 may be provided to identify in advance whether the connection pin 23 and the assembly hole 11 are aligned before assembly and appropriately adjust the position of the connection pin 23 according to the identified alignment state. In addition, the manufacturing apparatus 100 may be provided as described above to perform the assembly of the connection pin 23 and the assembly hole 11 in a state where the position of the connection pin 23 is appropriately aligned. Accordingly, assembly defects, component damage during the assembly process, or the like may be appropriately prevented.

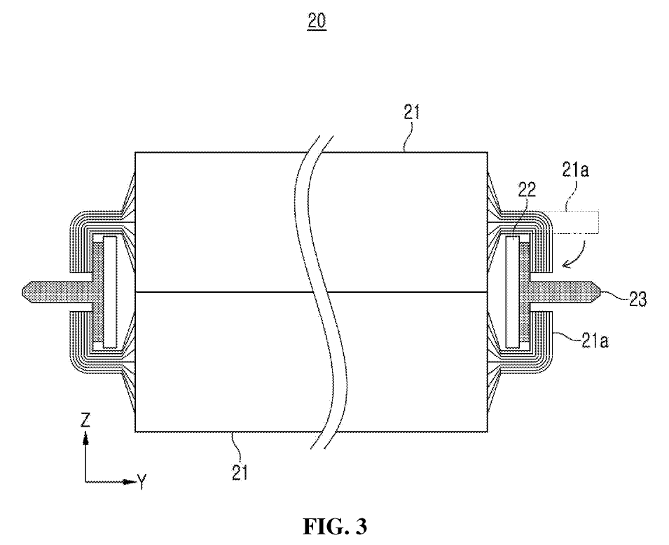

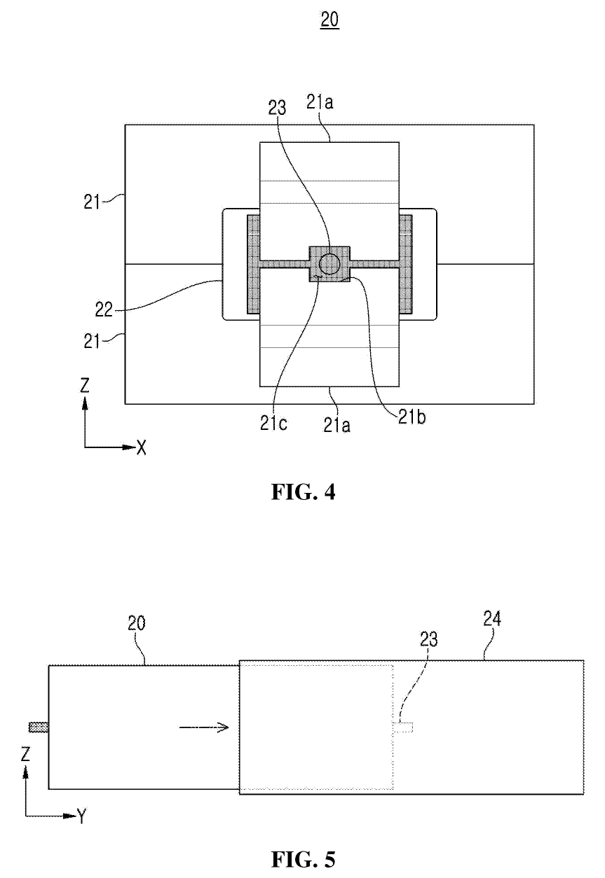

FIG. 3 is a side view showing a secondary battery being processed. FIG. 4 is a front view of the secondary battery being processed shown in FIG. 3. FIG. 5 is a side view showing a state in which the secondary battery being processed shown in FIG. 3 is inserted into a case.

FIGS. 3 to 5 illustratively show one secondary battery 20 being processed. In some embodiments, the secondary battery 20 being processed may be provided as a prismatic cell type. Additionally, the above-described manufacturing apparatus 100 may be used for the alignment and assembly between the connection pin 23 and the assembly hole 11 in the secondary battery 20. However, the application target of the manufacturing apparatus 100 is not necessarily limited to the illustrated examples, and the manufacturing apparatus 100 may be appropriately applied to cylindrical-type cells, pouch-type cells, coin-type cells, or other cells having non-standard shapes, within a scope that appropriately incorporates the technical concept described below.

Referring to FIGS. 3 and 4, in some embodiments, the secondary battery 20 being processed may comprise one or more electrode assemblies 21. For example, as shown in the drawing, two sets of electrode assemblies 21 may be provided, one above the other. However, the number of electrode assemblies 21 may be increased or decreased as needed, and is not necessarily limited to the example.

Although not shown, in some embodiments, each of the electrode assemblies 21 may comprise a positive electrode and a negative electrode, and the positive electrode and the negative electrode may be disposed with a separator disposed therebetween. Additionally, the electrode assembly 21 may be provided in a structure in which the positive electrode and the negative electrode are stacked or wound. However, in the embodiment of the present disclosure, the electrode assembly 21 may be provided in various known configurations, and the internal configuration or the like is not particularly limited.

In some embodiments, the electrode assembly 21 may comprise an electrode tab 21a. The electrode tab 21a may be disposed to be exposed at one end portion of the electrode assembly 21. In addition, the electrode tab 21a may be provided to be electrically connected to the connection pin 23 and a current collector 22 described below. In some embodiments, the electrode tab 21a may be provided as a pair of electrode tabs 21a corresponding to the positive electrode and the negative electrode. Additionally, the pair of electrode tabs 21a may be disposed to be spaced apart from each other on one surface or both surfaces of the electrode assembly 21. For example, as shown in the drawing, the pair of electrode tabs 21a may be disposed to be spaced apart from each other in the front-rear direction at both ends of the electrode assembly 21.

In some embodiments, the secondary battery 20 being processed may be provided with the current collector 22. The current collector 22 may be provided to be electrically connected to the electrode tab 21a. Specifically, as shown in the drawing, the current collector 22 may be disposed at one end of the electrode assembly 21, and the electrode tab 21a may be bent toward the current collector 22 disposed as described above and provided to be joined to the current collector 22. For example, the electrode tab 21a may be provided to be joined to the current collector 22 through welding, a conductive adhesive, or the like. Accordingly, the electrode tab 21a may be electrically connected to the current collector 22.

In some embodiments, one current collector 22 may be provided to be electrically connected to a plurality of electrode tabs 21a. For example, as shown in the drawing, the secondary battery 20 being processed may be provided with two sets of electrode assemblies 21, and the electrode tabs 21a of each of the electrode assemblies 21 may be bent upward or downward toward the current collector 22 to be electrically connected to the current collector 22. Additionally, each electrode tab 21a may be provided with a cutout 21b to appropriately expose the current collector 22 or the connection pin 23. The cutout 21b may be provided by removing a portion of the electrode tab 21a at the arrangement position of the connection pin 23. The cutout 21b may form a third opening 21c in one surface of the bent electrode tab 21a. Additionally, the connection pin 23 may be appropriately exposed to the outside of the electrode tab 21a through the third opening 21c.

Meanwhile, in some embodiments, the secondary battery 20 being processed may be provided with the connection pin 23. The connection pin 23 may be provided to be joined to the current collector 22 to be electrically connected to the current collector 22. In some embodiments, the connection pin 23 may be provided to be partially or entirely integrated with the current collector 22. Additionally, the connection pin 23 may be provided in a pin shape that extends a predetermined amount in the longitudinal direction. The connection pin 23 may be appropriately exposed to the outside of the electrode tab 21a through the third opening 21c.

Referring to FIG. 5, the secondary battery 20 being processed, which is provided with the connection pin 23 as described above, may be inserted into a case 24. In some embodiments, the case 24 may be provided in a substantially rectangular parallelepiped shape with open front and rear surfaces. Additionally, the secondary battery 20 being processed may be inserted into the case 24 through an opening provided in the front surface or the rear surface of the case 24. The secondary battery 20 being processed may be fed into the above-described manufacturing apparatus 100 while assembled with the case 24 as described above, and the manufacturing apparatus 100 may be provided to align and assemble the cap 10 to the fed secondary battery 20 being processed.

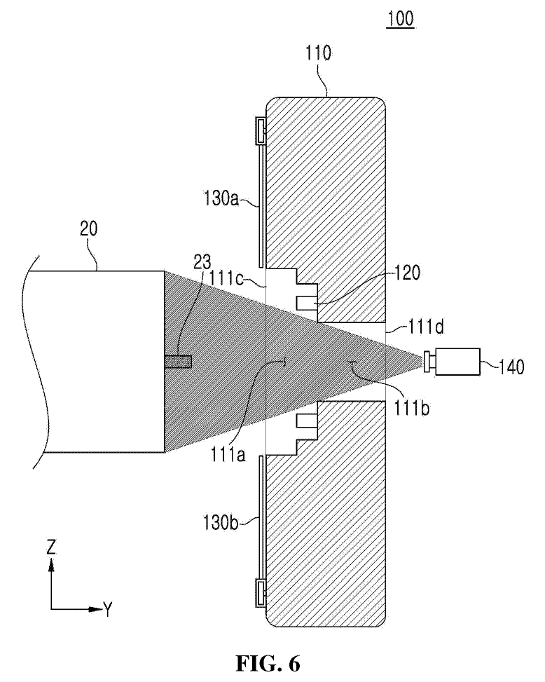

FIG. 6 is a first operating state view of the manufacturing apparatus shown in FIG. 1.

Referring to FIG. 6, first, the secondary battery 20 being processed may be fed into the manufacturing apparatus 100. Additionally, when the secondary battery 20 being processed is fed, the vision camera 140 may scan the secondary battery 20 being processed at the fed location. The vision camera 140 may be provided to scan one surface of the secondary battery 20 being processed through the access hole 111, thereby determining the welding state of the electrode tab 21a, whether an appropriate assembly space for the cap 10 is secured, and the like. The present operation may be performed before the cap 10 is fed into the manufacturing apparatus 100, and accordingly, the vision camera 140 may be operated to scan the entire one surface of the secondary battery 20 on which the electrode tab 21a is disposed.

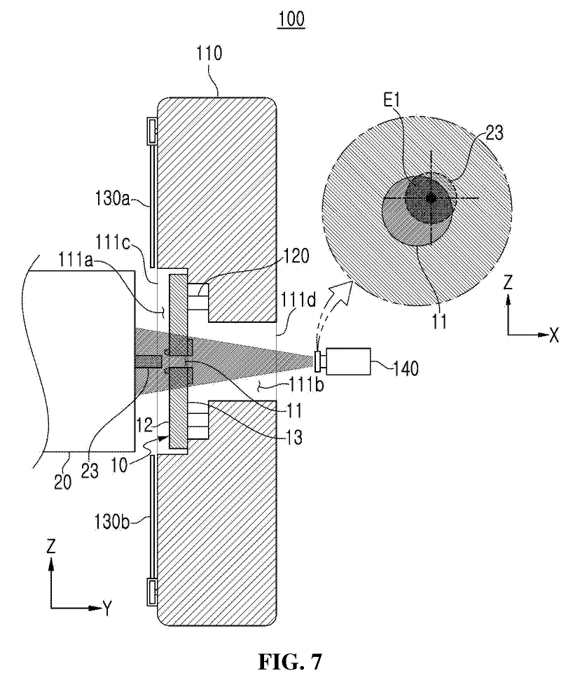

FIG. 7 is a second operating state view of the manufacturing apparatus shown in FIG. 1.

Referring to FIG. 7, subsequently, the cap 10 may be fed into the manufacturing apparatus 100. The cap 10 may be disposed in the first space 111a of the access hole 111 and supported by the cap supporter 120.

Additionally, the secondary battery 20 being processed may be moved to a standby position. For example, the manufacturing apparatus 100 may be advanced a predetermined distance toward the secondary battery 20 being processed, and accordingly, the secondary battery 20 being processed may be moved and disposed in a standby position adjacent to the front surface 112 of the body 110.

In some embodiments, the vision camera 140 may scan the assembly hole 11 provided in the cap 10 when the cap 10 and the secondary battery 20 being processed are disposed as described above. That is, the vision camera 140 may scan the assembly hole 11 in the rear surface of the cap 10 through the access hole 111 while the cap 10 and the secondary battery 20 being processed are disposed. In some embodiments, the present operation may be performed to scan only a partial region that includes the assembly hole 11.

In some embodiments, the vision camera 140 may be provided to identify whether the connection pin 23 is appropriately aligned through an occupied area E1 of the connection pin 23 exposed through the assembly hole 11. Specifically, the vision camera 140 may scan the assembly hole 11 and extract an area where the connection pin 23 is exposed from the image of the scanned assembly hole 11. In addition, the vision camera 140 may calculate the occupied area E1 of the connection pin 23 corresponding to the above exposure region, and identify whether the connection pin 23 is appropriately aligned according to the calculated occupied area E1 of the connection pin 23. That is, the suitability or unsuitability of the alignment state may be determined.

For example, when the assembly hole 11 is aligned in a correct position with the connection pin 23, the connection pin 23 may be fully exposed through the assembly hole 11, and accordingly, the occupied area E1 of the connection pin 23 may be calculated to be a reference value or more. In this case, the connection pin 23 may be determined to be in a suitable alignment state, and a subsequent assembly process may be performed. As another example, as shown in the drawing, when the assembly hole 11 is not appropriately aligned with the connection pin 23, only a portion of the connection pin 23 may be exposed through the assembly hole 11, and accordingly, the occupied area E1 of the connection pin 23 may be calculated to be below the reference value. In this case, the connection pin 23 may be determined to be in an unsuitable alignment state, and after the alignment of the connection pin 23 is first performed, a subsequent assembly process may be performed.

In some embodiments, when the connection pin 23 is not detected in the scanned image of the assembly hole 11, the manufacturing apparatus 100 may be provided to temporarily stop the process and send a notification signal, or discharge the corresponding secondary battery 20 being processed to the outside.

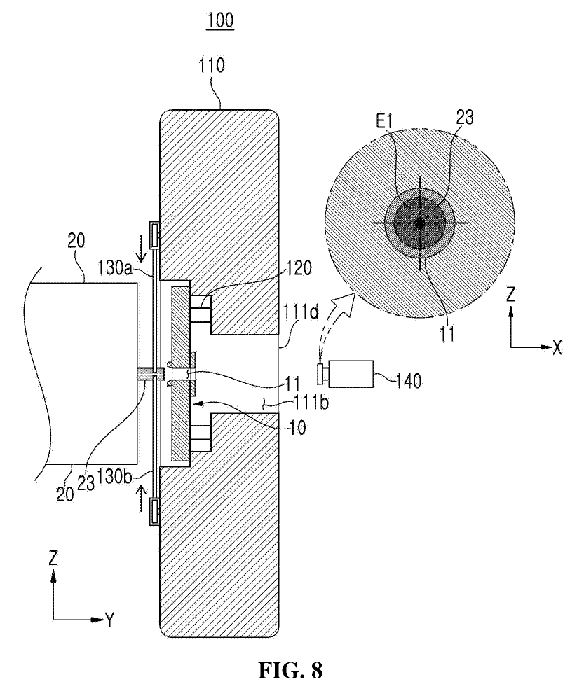

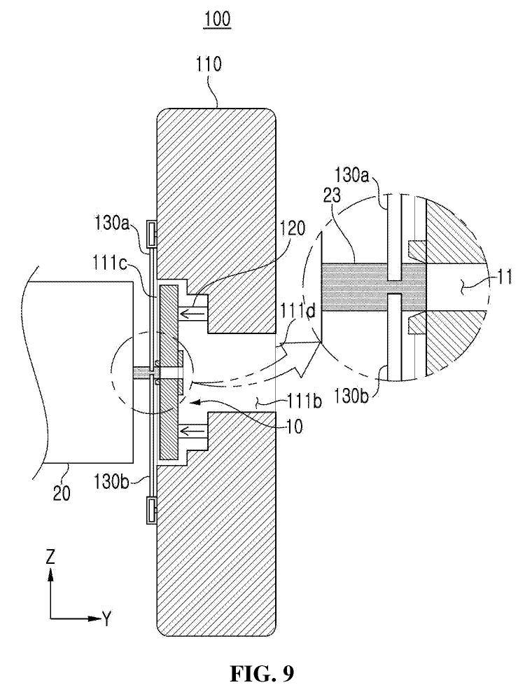

FIG. 8 is a third operating state view of the manufacturing apparatus shown in FIG. 1.

FIG. 8 illustrates an operation when the alignment state of the connection pin 23 is unsuitable. Referring to FIG. 8, when the alignment is unsuitable, an alignment process of adjusting the position of the connection pin 23 may be performed in advance. First, the pin guide 130 may be advanced toward the connection pin 23 disposed in the standby position to be coupled to the connection pin 23. For example, as shown in the drawing, the first and second pin guides 130a and 130b, which are disposed up and down, respectively, may be advanced toward the connection pin 23 to clamp and fix the connection pin 23 in the vertical direction. In addition, the pin guide 130 may be moved left and right and/or up and down while coupled to the connection pin 23, thereby aligning the connection pin 23 with the assembly hole 11 in the correct position (see FIG. 2). Meanwhile, the vision camera 140 may provide feedback regarding the alignment state of the connection pin 23 and the assembly hole 11 to the pin guide 130.

FIG. 9 is a fourth operating state view of the manufacturing apparatus shown in FIG. 1.

Referring to FIG. 9, subsequently, the cap supporter 120 may be advanced a predetermined distance toward the connection pin 23. Accordingly, a portion of the connection pin 23 may be inserted into the assembly hole 11 provided in the cap 10. That is, the connection pin 23 and the assembly hole 11 may be temporarily assembled.

In some embodiments, such temporary assembly may be performed while the pin guide 130 is coupled to the connection pin 23. That is, while the pin guide 130 is coupled to the connection pin 23 and supports the connection pin 23, the cap supporter 120 may be advanced a predetermined distance toward the connection pin 23, and accordingly, the connection pin 23 may be temporarily assembled to the assembly hole 11. By performing such temporary assembly while the pin guide 130 is supporting the connection pin 23, smoother insertion of the connection pin 23 may be achieved. In addition, the pin guide 130 provided in a plate form may be appropriately disposed in the space between the secondary battery 20 and the cap 10 to assist such temporary assembly.

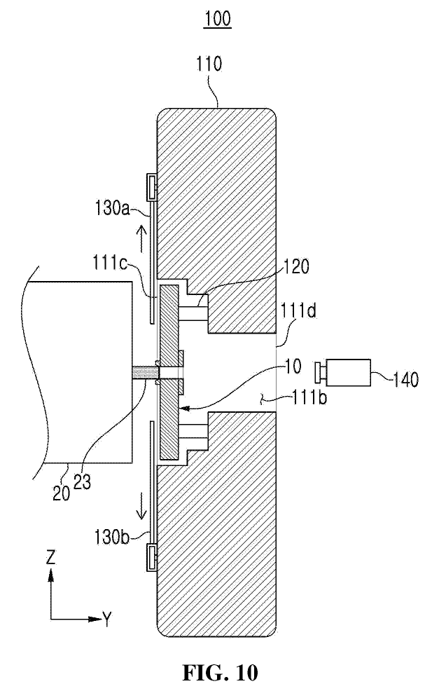

FIG. 10 is a fifth operating state view of the manufacturing apparatus shown in FIG. 1.

Referring to FIG. 10, subsequently, the pin guide 130 may be separated from the connection pin 23 and returned to its initial position. Additionally, the connection pin 23 may maintain its assembly position while temporarily assembled in the assembly hole 11.

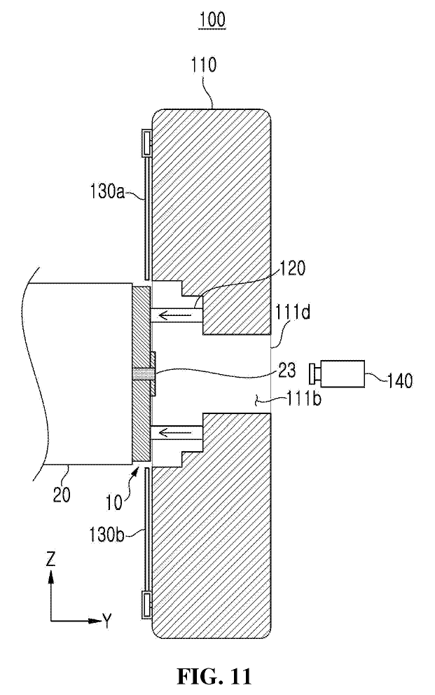

FIG. 11 is a sixth operating state view of the manufacturing apparatus shown in FIG. 1.

Referring to FIG. 11, subsequently, the cap supporter 120 may be advanced a predetermined distance again toward the connection pin 23. Accordingly, the connection pin 23 may be fully inserted into the assembly hole 11 and assembled. That is, the cap 10 may be assembled on the secondary battery 20 being processed. Afterward, the cap 10 may be fully assembled to the secondary battery 20 being processed through processes such as pre-welding and main-welding. However, in the embodiment of the present disclosure, the subsequent assembly process of the cap 10, such as pre-welding, is not particularly limited.

As described above, some embodiments of the present disclosure may provide an apparatus for manufacturing a secondary battery.

Additionally, some embodiments of the present disclosure may appropriately align the assembly position between the electrode assembly and the cap during the assembly process of the secondary battery. In some embodiments, the vision camera may identify the position of the connection pin through the access hole, thereby contributing to quickly and effectively determining the alignment status between the connection pin and the assembly hole. In addition, the pin guide may adjust the position of the connection pin according to the position of the connection pin identified by the vision camera, thereby contributing to achieving the alignment of the assembly position as described above.

Additionally, some embodiments of the present disclosure may prevent an assembly defect between the electrode assembly and the cap. In some embodiments, the connection pin provided on the electrode assembly and the assembly hole provided in the cap may be appropriately position-adjusted to an aligned state before assembly, thereby contributing to preventing assembly defects as described above.

In addition, some embodiments of the present disclosure may prevent an increase in manufacturing costs and degradation in quality due to assembly defects.

Embodiments of the present disclosure can provide an apparatus for manufacturing a secondary battery.

Additionally, some embodiments of the present disclosure can appropriately align the assembly position between an electrode assembly and a cap during the assembly process of a secondary battery.

Additionally, some embodiments of the present disclosure can prevent an assembly defect between an electrode assembly and a cap.

Additionally, some embodiments of the present disclosure can prevent increased manufacturing costs and quality degradation due to assembly defects.

The technical effects that can be obtained through the embodiments of the present disclosure are not necessarily limited to the effects mentioned above. Other technical effects that are not mentioned may be clearly understood by those skilled in the art to which the present disclosure belongs from other descriptions in the specification, such as the detailed description.

The above description is merely an example applying the principles of the present disclosure, and other configurations may be further included without departing from the scope of the present disclosure.

What is claimed is:

1. An apparatus for manufacturing a secondary battery, comprising:
a body provided with an access hole;
a cap supporter disposed on the body to support a cap;
a pin guide configured to adjust a position of a connection pin assembled to the cap; and
a vision camera configured to identify the position of the connection pin through the access hole.

2. The apparatus of claim 1, wherein the access hole comprises:
a first space in which the cap is disposed; and
a second space which extends from the first space and through which an assembly hole provided in the cap is exposed to the vision camera.

3. The apparatus of claim 1, wherein the cap supporter is provided to allow the cap to advance toward the connection pin.

4. The apparatus of claim 1, wherein the cap is provided so that a first surface thereof is advanced toward the connection pin to be assembled with the connection pin, and
the cap supporter is fastened to a second surface of the cap, which is opposite to the first surface, to support the cap.

5. The apparatus of claim 1, wherein the pin guide is provided so that the pin guide is advanced toward the connection pin to be coupled to the connection pin, or retracted from the connection pin to be separated from the connection pin.

6. The apparatus of claim 1, wherein the pin guide is provided to adjust the position of the connection pin on a plane intersecting an assembly direction of the connection pin.

7. The apparatus of claim 1, wherein the pin guide is provided to be movable on a plane intersecting an assembly direction of the connection pin.

8. The apparatus of claim 1, wherein the pin guide is provided to be movable along a first rail and a second rail that extend in directions intersecting each other.

9. The apparatus of claim 1, wherein the pin guide is provided in a plate form having a predetermined thickness in an assembly direction of the connection pin to enter a space between the connection pin and the cap that are disposed in a standby position.

10. The apparatus of claim 1, wherein the pin guide has one end provided with a pin-coupling groove coupled to the connection pin.

11. The apparatus of claim 1, wherein the pin guide comprises:
a first pin guide coupled to one side of the connection pin; and
a second pin guide provided to correspond to the first pin guide to be coupled to the remaining region of the connection pin.

12. The apparatus of claim 1, wherein the vision camera is provided to scan an assembly hole provided in the cap through the access hole and identify whether the connection pin is aligned through an occupied area of the connection pin exposed through the assembly hole.

13. The apparatus of claim 1, wherein the vision camera is provided to identify whether the connection pin is aligned when the connection pin approaches a standby position, and
the pin guide is provided to adjust the position of the connection pin to an appropriate state when the identified alignment state is not suitable.

14. The apparatus of claim 1, wherein the pin guide is provided to be coupled to the connection pin when the connection pin approaches a standby position, and
the cap supporter is provided to advance the cap while the pin guide is coupled to the connection pin so that a portion of the connection pin is inserted into an assembly hole provided in the cap.

15. The apparatus of claim 14, wherein the pin guide is provided to be separated from the connection pin when the portion of the connection pin is inserted into the assembly hole, and
the cap supporter is provided to advance the cap when the pin guide is separated from the connection pin so that the connection pin is fully inserted into the assembly hole.
